(19) United States
(12) Patent Application Publication
(10) Pub. No.: US 2022/0212041 A1
(43) Pub. Date: Jul. 7, 2022

(54) REUSABLE PROTECTIVE SILICONE FACE MASK

(71) Applicant: MICHAEL REICHMANN, NEW YORK, NY (US)

(72) Inventor: MICHAEL REICHMANN, NEW YORK, NY (US)

(21) Appl. No.: 17/142,448

(22) Filed: Jan. 6, 2021

(51) Int. Cl. A62B 23/02; A41D 13/11; A41D 27/04; A62B 7/10; A62B 9/04

(52) U.S. Cl. CPC A62B 23/025; A41D 13/1138; A62B 18/084; A62B 7/10; A62B 9/04; A41D 27/04

(57) ABSTRACT

The present invention provides a protective face mask with breathing holes and having a removable and replaceable rear inner filter on the back of the face mask in order to provide a secure and safe mask and filter that provides additional resistance to penetration of pollutants, germs, and contaminants. The breathing holes make it easier for the user to breathe through the mask and filter. The rear filter has a continuous outer edge for being received in a continuous outer channel formed around the entire periphery of the rear face of the mask. Also, the entire edge of the inner filter is securely held in place in the continuous channel extending around the entire periphery of the face mask, with removable clips mounted on the filter, which have tabs for securely engaging gripping holes formed on each side of the continuous outer channel in the mask.

### FIELD OF THE INVENTION

The present invention relates to a novel and reusable protective face mask having breathing holes and a removable inner filter layer fitted on the back surface of the face mask for a more secure and safe mask. The face mask and removable inner filter are designed to protect the user from airborne pollutants and particulates from any source, and the breathing holes make it easier for the wearer to breathe without exertion.

### BACKGROUND OF THE INVENTION

Although many protective face masks have been developed to prevent pollutants and contaminants, none of them have the structure, function and advantages of the present invention. For example, the present face mask is reusable with easy to breathe holes, and the filter layer is easily removable and replaceable.

### DESCRIPTION OF THE PRIOR ART

The prior art protective face masks do not provide the features and advantages of the present invention.

For example, U.S. Pat. No. 5,080,094 discloses a face mask having a filter liner made of charcoal, and includes a retainer for holding the filter.

Also, U.S. patent publication no. 2015/0034098 discloses a face mask having an air filtration mask having a filter which employs studs to hold the filter.

Further, U.S. Pat. No. 2,845,927 discloses a face mask, a filter, and an inner frame A for holding the filter.

In addition, U.S. patent publication no. 2017/0065838 discloses a face mask, a filter, and a seal around an outer edge of the mask.

As explained herein, the present invention provides structure, functions, and advantages not found in the prior art.

### OBJECTS OF THE INVENTION

It is an object of the present invention to provide an improved protective face mask with breathing holes, and a removable and replaceable inner filter insert in the back of the mask, which prevents germs, pollutants, and contaminates from entering the nose and mouth of the wearer.

Another object of the present invention is to provide a face mask having a continuous channel around the inside periphery of the mask for tightly receiving the replaceable inner filter.

Another object of the present invention is to provide retention clips for holding the filter securely in place with the mask.

Other objects of the present invention are apparent from the following description.

### SUMMARY OF THE INVENTION

The present invention provides a protective face mask with breathing holes and having a removable and replaceable rear inner filter on the back of the face mask in order to provide a secure and safe mask and filter that provides additional resistance to penetration of pollutants, germs, and contaminants. The breathing holes make it easier for the user to breathe through the mask and filter. The rear filter has a continuous outer edge for being received in a continuous outer channel formed around the entire periphery of the rear face of the mask. Also, the entire edge of the inner filter is securely held in place in the continuous channel extending around the entire periphery of the face mask, with removable clips mounted on the filter, which have tabs for securely engaging gripping holes formed on each side of the continuous outer channel in the mask.

### BRIEF DESCRIPTION OF THE DRAWINGS

FIG. 1 is a perspective view of the front of the mask;

FIG. 2 is another perspective view of the front of the mask;

FIG. 3 is a perspective view of the rear face of the mask;

FIG. 4 is an exploded view of the mask and the filter, which is placed inside the mask;

FIG. 5 is an exploded view of the mask and the filter, which is placed inside the mask;

FIG. 6 is a partial perspective view of the channel on the inside of the mask for receiving the removable filter;

FIG. 7 is a perspective view of the mask and filter showing the filter clips on opposite edges of the filter for holding it in place on the rear face of the mask;

FIG. 8 is a perspective view of the filter clip showing the details of its teeth and snap in pins; and

FIG. 9 is a perspective view of the filter clip showing the details of the opposite side of the filter clip.

### DETAILED DESCRIPTION OF THE PREFERRED EMBODIMENT

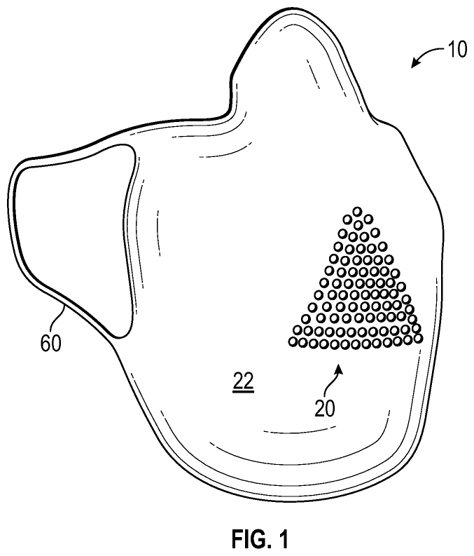

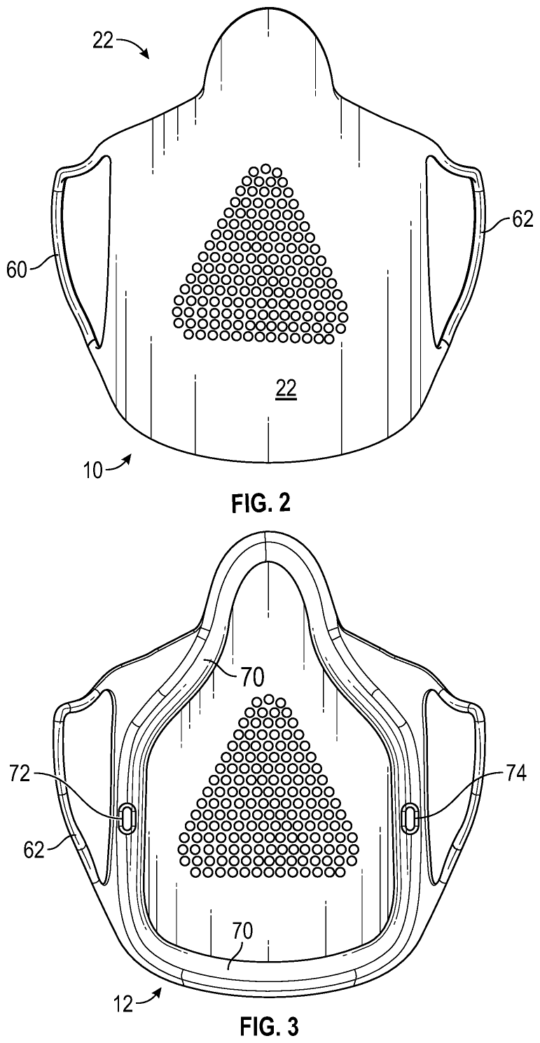

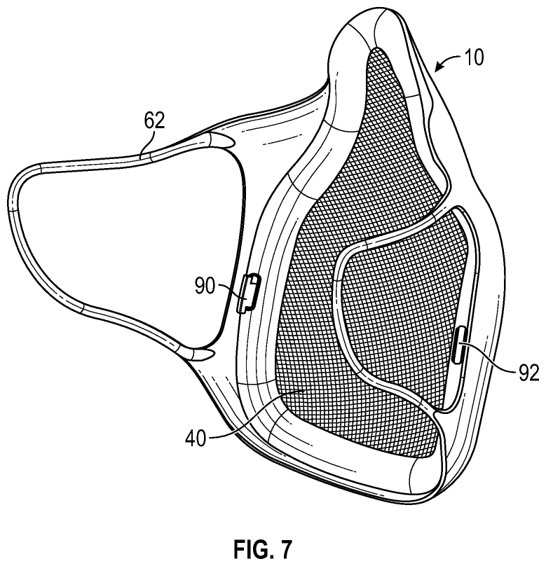

The present invention, as shown in FIGS. 1 through 5, and 7, provides a protective face mask 10 to improve resistance to germs and contaminants. The rear face 12 of the mask 10 is made to more closely fit the face of the wearer for more security and safety. A removable rear filter insert and liner 40 is provided, which is replaceable and removable from the mask 10.

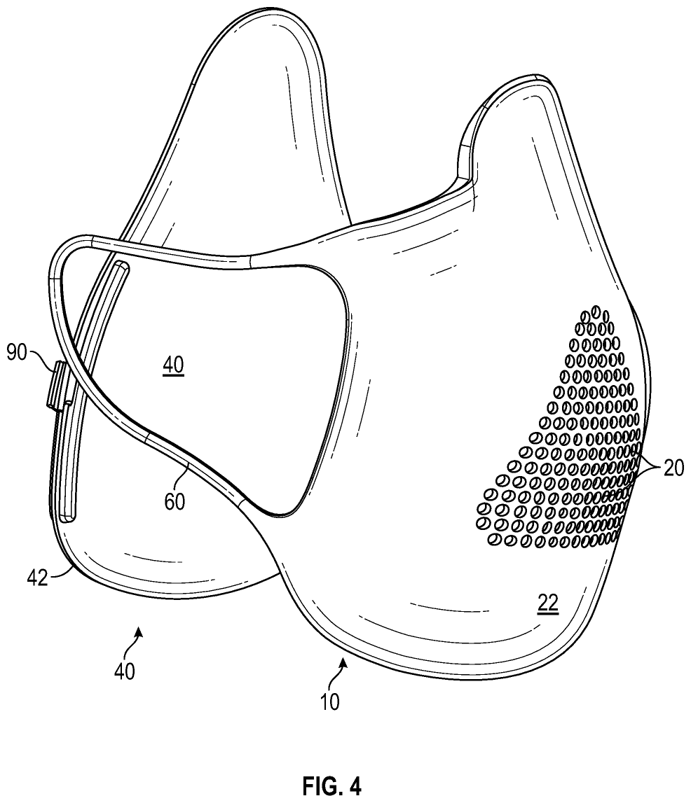

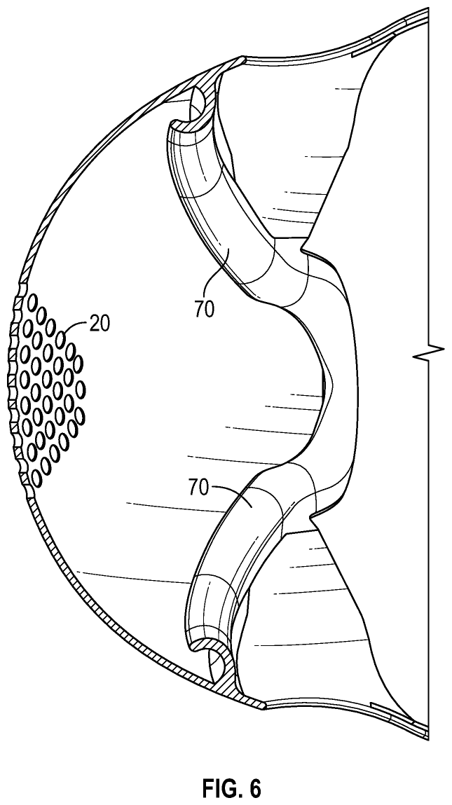

The face mask 10 is reusable and disposable, and prevents germs and other infectious matter in the air that the wearer is breathing. As shown in FIGS. 1 through 6, the mask 10 is perforated with multiple breathing holes or vent holes 20 in the central area 22 to permit inhaled air to pass through the face mask 10 more easily. The face mask 10 covers the mouth and has a nose covering 22 the wearer, and generally conforms to the contour of the face of the wearer for comfort and style in the zone of contact between the face of the wearer and the mask 10. The mask is preferably made of silicone. The vent holes 20 in the front of the mask 10, as shown in FIGS. 1 and 4, are rounded, but can be of any other shape. The distance between the vent holes 20 is between 1.45 mm to 2.5 mm, but 2.5 mm is the preferred size of the vent holes 20. Also, the diameter of each vent hole 20 is between 2.55 mm to 3.5 mm, but 2.55 mm is the preferred size.

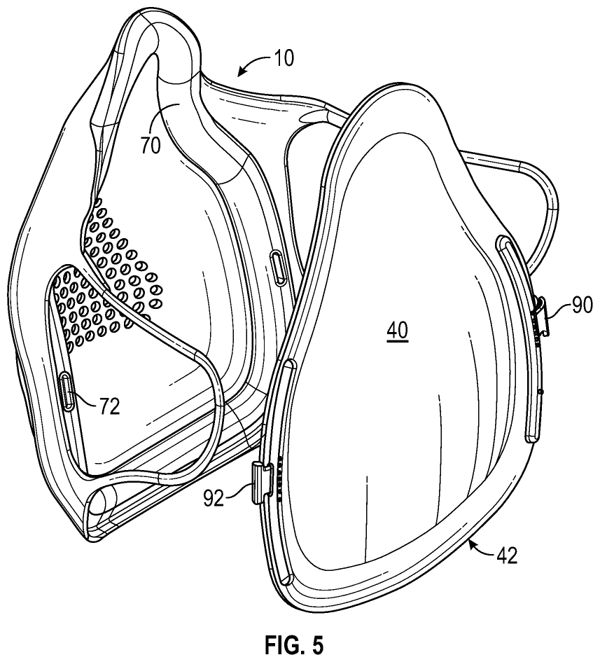

As shown in FIGS. 4 and 5, the mask 10 supports an interior removable and replaceable filter liner 40 that is made of a fabric sheet that covers the breathing holes 20 and the entire inside face of the mask 10. The edge 42 of the filter 40 is retained on the inside of the face mask 10 by being received in a continuous inner channel 70, which extends around the entire periphery of the back face of mask 10.

In addition, filter liner 40 is attached to the interior side 12 of the face mask 10. The holes 72 on each side of the face mask 10, as shown in FIGS. 3 and 5, are provided to help hold the filter liner 40 in place. The outer edge 42 of the filter liner 40 is detachably placed in the continuous inner channel 70 on the inside face of the mask 10, as shown in FIGS. 3, 5, and 6, to hold the filter 40 in place. The filter 40 provides comfort and safety to the user, and the filter 40 is held in place to direct air flow through the filter media 40.

The filter 40 has a unique outline and shape in order for its edge 42 to fit into the internal channel 70 that surrounds the entire inner periphery of the mask 10. The filter 40 is a N95 grade mask made of a fabric 80, and is an industry standard fabric. The filter 40 has two holes along each of the right and left edges for attaching filter 40 to two filter clips 90, as shown in FIGS. 4 and 5.

FIG. 5 shows a rear view of the mask 10 clearly showing the continuous channel 70 around the entire periphery of the rear face 12 of the mask 10 for receiving the edge 42 of the internal filter 40. The entire edge of the filter 40 fits into the continuous channel 70 around the entire face of the mask 10. Channel 70 provides an air seal, comfort and holds the edge 42 of filter 40 in the channel 70.

As shown in FIGS. 1, 2, and 4, the face mask 10 also has two elastic ear loop straps 60 and 62 on its two sides, and one end of the first strap 60 is attached to one end of the face mask 10, and the other end of the second strap 62 is attached to the other end to the ear of the wearer.

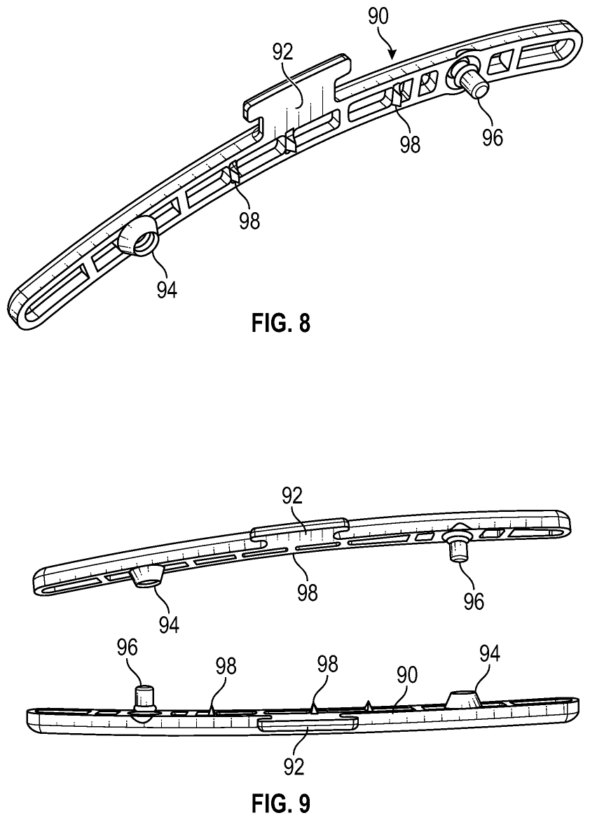

The outer two edges of the filter 40 have two or more holes for receiving two plastic clips 90 for more securely holding the filter 40 to the inside face of the mask 10. As shown in FIGS. 4 and 5 and 7 through 9, the filter holding clips 90 have teeth 92, a female snap fit pin 94, and a male snap fit pin 96, all placed on the inside surface of clip 90 to hold the filter 40 securely in place once installed within the continuous channel 70 on the face mask 10.

As shown in FIGS. 3, 5 and 7, the protective mask 10 also shows the continuous channel 70 having two holes 72, 74 for receiving two holding tabs to hold the filter liner 40 more securely within the continuous channel 70 on the face mask 10. The holding clips 90 also have a recess 92 for receiving and holding the edge of the filter liner 40 securely within the recess in the holding clips 90.

As shown in FIGS. 4, 5, and 7 through 9, the holding clips 90 and 92 each have at least two snap elements 94 and 96 for engaging two matching snap elements 98 on the other holding clip 92. This structure securely fastens the edges of the filter liner 40 within the continuous recess 70 using the holding clips 90 and 92.

### ADVANTAGES OF THE PRESENT INVENTION

It is an advantage present invention to provide an improved protective face mask with breathing holes, and a removable and replaceable inner filter insert in the back of the mask, which prevents germs, pollutants, and contaminates from entering the nose and mouth of the wearer.

Another advantage of the present invention is to provide a face mask having a continuous channel around the inside periphery of the mask for tightly receiving the replaceable inner filter.

Another advantage of the present invention is to provide retention clips for holding the filter securely in place with the mask.

Other advantages of the present invention are apparent from the foregoing description.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1) A protective face mask for filtering air, comprising:
a) a protective face mask having a flexible, front surface and having breathing air holes in the center of said face mask for breathing air, and said face mask having an inner surface for covering the face of the wearer;
b) a removable filter liner for placing on the back surface of said face mask, said filter liner having a continuous for filtering the air passing through said air holes of said mask; and
c) said inner surface of said face mask having a continuous channel extending around the periphery of said inner surface of said face mask for receiving the continuous edge of said filter liner in said continuous channel.

2) A protective face mask in accordance with claim 1, having two removable holding clips for placing on each side of said filter liner, each of said holding clips having holding tabs for engaging said continuous channel on said face mask, for securely holding said filter liner within said continuous channel on said face mask.

3) A protective face mask in accordance with claim 1, wherein said continuous channels has two holes for receiving said two holding tabs to hold said filter liner within said continuous channel on said face mask.

4) A protective face mask in accordance with claim 2, wherein each of said holding clips have a recess for receiving and holding the edge of said filter liner securely within said recess in said holding clips.

5) A protective face mask in accordance with claim 3, wherein each of said holding clips further include at least two snap elements for engaging two matching snap elements on the other holding clip, for securely fastening the edge of said filter liner securely within said recess in said holding clip.
